(19) United States
(12) Patent Application Publication
(10) Pub. No.: US 2019/0330709 A1
(43) Pub. Date: Oct. 31, 2019

(54) METHOD FOR HEAT TREATING A CRANKSHAFT FOR A VEHICLE PROPULSION SYSTEM

(71) Applicant: GM GLOBAL TECHNOLOGY OPERATIONS LLC, Detroit, MI (US)

(72) Inventors: Jianghuai Yang, Rochester Hills, MI (US); Sheri K. Kurgin, Macomb, MI (US); Qigui Wang, Rochester Hills, MI (US); James D. Cremonesi, Linden, MI (US); Daniel J. Wilson, Linden, MI (US)

(21) Appl. No.: 15/964,728

(22) Filed: Apr. 27, 2018

(51) Int. Cl. C21D 9/30; F16C 3/06; C21D 1/10; H05B 6/40

(52) U.S. Cl. CPC C21D 9/30; F16C 3/06; F16C 2223/18; H05B 6/40; C21D 1/10

(57) ABSTRACT

A method for heat treating a crankshaft surface on a crankshaft for a vehicle propulsion system includes heating the crankshaft surface to a first temperature and heating the crankshaft surface to a second temperature that is higher than the first temperature.

### FIELD

The present disclosure relates to a system and method for heat treating a crankshaft for a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

An engine's crankshaft converts reciprocating linear movement of a piston into rotational movement about a longitudinal axis to provide torque to propel a vehicle, such as but not limited to a train, a boat, a plane, or an automobile. Crankshafts are a vital part of an engine, and are a starting point of engine design. Crankshaft design affects the overall packaging of the engine, and thereby the total mass of the engine. Accordingly, minimizing the size and/or mass of the crankshaft reduces the size and mass of the engine, which has a compounding effect on the overall size, mass and fuel economy of the vehicle.

The crankshaft includes at least one crankpin that is offset from the longitudinal axis, to which a reciprocating piston is attached via a connecting rod. Force applied from the piston to the crankshaft through the offset connection therebetween generates torque in the crankshaft, which rotates the crankshaft about the longitudinal axis. The crankshaft further includes at least one main bearing journal disposed concentrically about the longitudinal axis. The crankshaft is secured to an engine block at the main bearing journals. A bearing is disposed about the main bearing journal, between the crankshaft and the engine block.

Due to the load and wear on the surfaces of the crank pins and on the main bearing journals, the hardening of these surfaces is important. One approach to this task is to inductively heat and then quench to harden these surfaces. The principle and mode of operation of surface hardening by means of inductors has long been known and will not be dealt with in detail here. Basically, higher-frequency voltages are used to induce an eddy current in the surface zone of the work piece which is to be hardened. When this happens, the surface of the work piece becomes rapidly heated to a certain temperature. Hardening is then accomplished by quenching.

The induction hardening of crankshafts has created problems in the past. One problem is that, while induction hardening increases hardness and strength, hardening generates an excessive amount of residual stress in the tensile direction which imposes the detrimental risk promoting premature fatigue failure of the hardened portion in operating conditions. The tensile residual stresses are a result of temperature variation in heating and cooling of the object and the volumetric change in hardening due to the specific volume difference between the original and new formed phases in the steel. If that sub-surface material is stressed sufficiently that material may develop cracks which may propagate and result in failure of the crankshaft.

In order to reduce the weight of the crankshaft, a hollow section may be formed into and extend through each of the crankpins and main bearing journals. The crankshaft is typically formed or manufactured by a casting process, such as, but not limited to, a green sand casting process a shell mold casting process, or by forging a steel into the crankshaft. The problem of sub-surface residual tensile stress may be especially exasperated where, as explained above, the crankshaft may be hollow. While these crankshafts may have offered weight savings and heat transfer benefits, the reduction in the mass of material makes the effect of the subsurface residual stress performance more adversely pronounced.

Conventional attempts to alleviate or reduce the residual tensile stress have included pre-heating and/or post-hardening (e.g., high temperature tempering) the entire crankshaft in an oven or furnace. However, not only have these conventional methods proven ineffective at sufficiently reducing sub-surface residual tensile stress, exposing the entire crankshaft to elevated temperatures in this manner may adversely affect the material properties of those area which are unaffected by the induction hardening process and also may adversely reduce the effectiveness of the induction hardening process on those surfaces where those properties are desired. An improved method for locally induction hardening surfaces of a crankshaft is needed.

### SUMMARY

In an exemplary aspect, a method for heat treating a crankshaft surface on a crankshaft for a vehicle propulsion system includes heating the crankshaft surface to a first temperature and heating the crankshaft surface to a second temperature that is higher than the first temperature.

In this manner, the residual tensile stress in the subsurface material below a hardened crankshaft surface may be significantly reduced, crankshaft mass may be reduced, vehicle propulsion system engine efficiency and performance may be improved, potential crankshaft failures and/or fracturing may be significantly reduced and/or eliminated, production processes may be simplified, post-treatment process may be reduced and/or eliminated, the properties of the hardened surface may be improved, and the material properties of crankshaft may be improved overall.

In another exemplary aspect, the method further includes quenching the crankshaft surface to harden the crankshaft surface.

In another exemplary aspect, heating the crankshaft surface includes inductively heating the crankshaft surface.

In another exemplary aspect, inductively heating of the crankshaft surface to the first temperature includes applying an alternating current to a coiled conductor and inductively heating the crankshaft surface to the second temperature includes applying another alternating current to the coiled conductor.

In another exemplary aspect, heating the crankshaft surface to a first temperature includes applying a plurality of inductive field pulses to the crankshaft surface.

In another exemplary aspect, heating the crankshaft surface to a first temperature includes applying a first inductive field having a first intensity and heating the crankshaft surface to a second temperature includes applying a second inductive field having a second intensity that is higher than the first intensity.

In another exemplary aspect, heating the crankshaft surface to a first temperature includes inductively heating the crankshaft surface at a first heating rate and heating the crankshaft surface to a second temperature includes inductively heating the crankshaft surface at a second heating rate that is higher than the first heating rate.

In another exemplary aspect, heating the crankshaft surface to a first temperature includes applying a first inductive field for a first period of time and heating the crankshaft surface to a second temperature includes applying a second inductive field for a second period of time that is shorter than the first period of time.

In another exemplary aspect, the crankshaft surface is one or more of a crankpin surface and a bearing journal surface.

In another exemplary aspect, the crankshaft is a hollow crankshaft.

In another exemplary aspect, heating the crankshaft surface to a first temperature includes heating material underlying the crankshaft surface to a substantially uniform temperature.

In another exemplary aspect, the first temperature is below an austenitizing temperature of the crankshaft surface.

In another exemplary aspect, the first temperature is below a eutectoid temperature of the crankshaft surface.

In another exemplary aspect, the first temperature is below an AC1 temperature of the crankshaft surface.

In another exemplary aspect, the second temperature is above an austenitizing temperature of the crankshaft surface.

In another exemplary aspect, the second temperature is above an AC3 temperature of the crankshaft surface.

In another exemplary aspect, heating the crankshaft surface to a first temperature includes applying a first inductive field having a first power density and heating the crankshaft surface to a second temperature includes applying a second inductive field having a second power density that is higher than the first power density.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a fragmentary side elevation of a portion of a crankshaft with an induction heating coil disposed around a bearing surface;

FIG. 2A is a cross-sectional view of a crank pin portion of an exemplary crank shaft illustrating residual axial tensile stress;

FIG. 2B is a cross-sectional view of the crank pin portion of the exemplary crank shaft of FIG. 2A illustrating residual hoop tensile stress;

FIG. 3 is a graph 300 illustrating an exemplary induction pre-heating in accordance with the present disclosure;

FIG. 4 a graph 400 illustrating a reduction the residual tensile stress as a result of practicing an exemplary method of the present disclosure;

FIG. 5A is a cross-sectional view of a crank pin portion of an exemplary crank shaft illustrating residual axial tensile stress in accordance with the present disclosure;

FIG. 5B is a cross-sectional view of the crank pin portion of the exemplary crank shaft of FIG. 5A illustrating residual hoop tensile stress in accordance with the present disclosure; and

FIG. 6 is a graph 600 illustrating another exemplary induction pre-heating method in accordance with the present disclosure.

### DETAILED DESCRIPTION

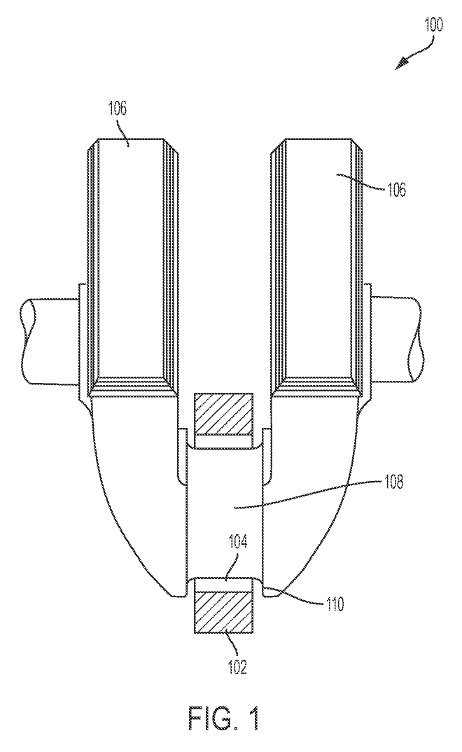

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner. Referring now to the drawings, wherein like reference numbers correspond to like or similar components throughout the several figures, FIG. 1 is a fragmentary side elevation of a portion of a crankshaft 100 with an induction heating coil 102 disposed around a surface 104 of a crank pin 108. The crankshaft 100 includes a pair of cheeks 106 connected via the crank pin 108. The surface 104 of the crank pin 108 transitions into the cheeks 106 via rounded corners or fillets 110. While the exemplary crankshaft 100 of FIG. 1 includes on a single crank pin 108, it is to be appreciated that a crankshaft may include any number of additional crank pins, main bearings and cheeks as required for the particular engine for which it is designed, without limitation.

In accordance with an exemplary aspect of the present disclosure, the surface 104 of the crank pin 108 is heated by the induction heating coil 102. The induction heating coil 102 may be of any configuration and the specific design of the coil 102 forms no part of the invention. The induction heating coil 102 may be energized from a suitable source of high frequency alternating electric current which causes a high density alternating current to be induced to flow in the bearing pin 108, which, in turn, generates heat within the bearing pin 108.

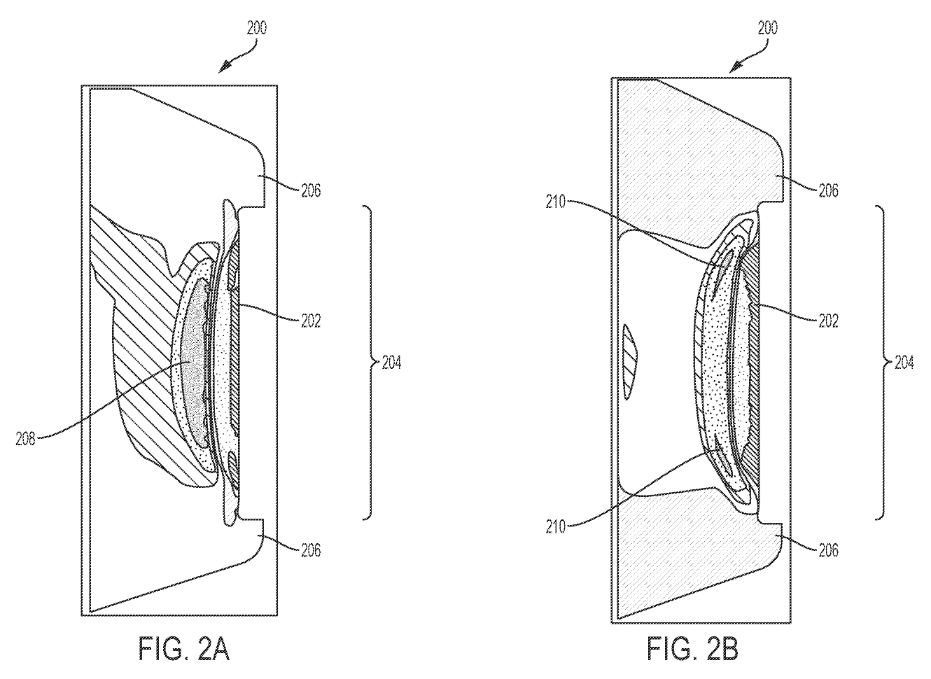

FIGS. 2A and 2B schematically illustrate the residual axial tensile stress and residual hoop tensile stress, respectively, in cross-sectional views of a crank pin portion 200 of another exemplary crankshaft having a hollow cross-section which has undergone inductive hardening of the surface 202 of the crank pin. FIGS. 2A and 2B clearly illustrate the magnitude of the residual stress in the material underlying the surface 202 of the crank pin. FIGS. 2A and 2B further illustrate the localization of the inductive hardening to the crank pin portion 204 which generally does not extend to the fillets 206 adjacent to the surface 202 of the crank pin 204 of the crankshaft. However, FIGS. 2A and 2B also illustrate the undesirable effect of the conventional inductive hardening method on the material underlying the surface 202. In particular, residual axial tensile stress is concentrated in an area generally indicated at 208 and residual hoop tensile stress is concentrated in areas generally indicated at 210. These residual tensile stress concentrations 208 and 210 remain despite conventional attempts to relieve the concentrations by a post-heating and/or a tempering operation after the induction hardening. As a result of the sub-surface residual tensile stress concentrations, under certain conditions, conventional crank shafts have been at risk of premature fatigue crack initiation in the sub-surface material and potential failure and/or fracture of the crankshaft.

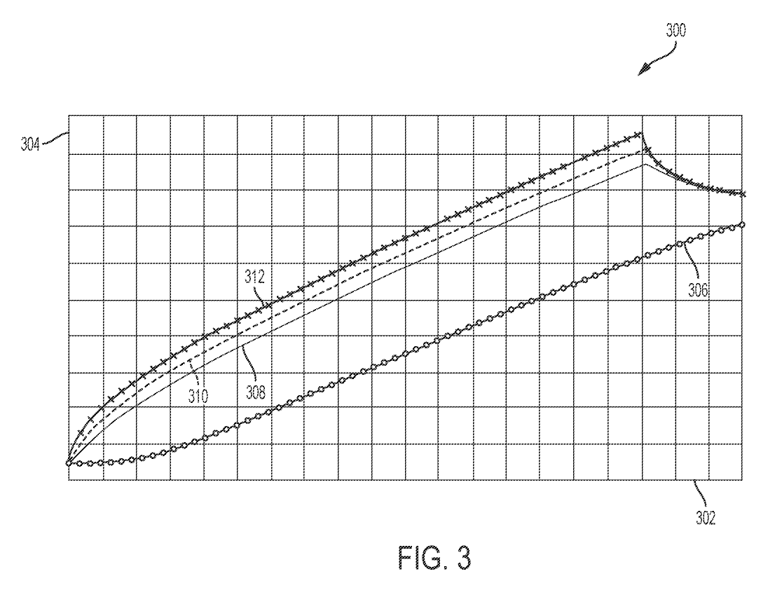

In an exemplary aspect of the present disclosure, prior to induction hardening of the crank pin surface(s), the crank pin is pre-heated via induction heating in a manner which results in more uniform temperature distribution in the areas of the crank pin which are subsequently treated to an induction hardening process. FIG. 3 is a graph 300 illustrating an exemplary induction pre-heating in accordance with the present disclosure. The horizontal axis 302 of the graph 300 corresponds to the elapse of time, while the vertical axis 304 corresponds to material temperature. Line 306 represents the material temperature of the material at the core of the crankshaft underlying the surface of the crankpin and lines 308, 310, and 312, illustrate the material temperatures progressing from closer to the core at 308 to the surface 312, respectively. In the example illustrated in graph 300, the peak surface temperature 312 reaches about 475 Celsius in about 34 seconds and the core temperature 306 reaches about 350 Celsius where the temperatures 306, 308, 310, and 312 substantially equalize at about six seconds after the induction pre-heating is complete. In this manner, the material temperatures are substantially equalized at a temperature elevated above room temperature prior to exposing the material to an induction hardening process. In an exemplary aspect, the peak material temperature that is reached during the inductive heating process is lower than the peak material temperature that is reached during the subsequent inductive hardening process.

In a further exemplary aspect, the induction hardening raises the temperature of the surface of the crankpin to a temperature which is below an AC1 temperature of the crankpin surface material. An AC1 temperature may correspond to a temperature at which austenite begins to form during heating. After pre-heating, the surface of the crankpin may then be inductively heated to a higher second temperature such as an AC3 temperature of the crankpin surface material. An AC3 temperature may correspond to a temperature at which transformation of ferrite to austenite is completed during heating.

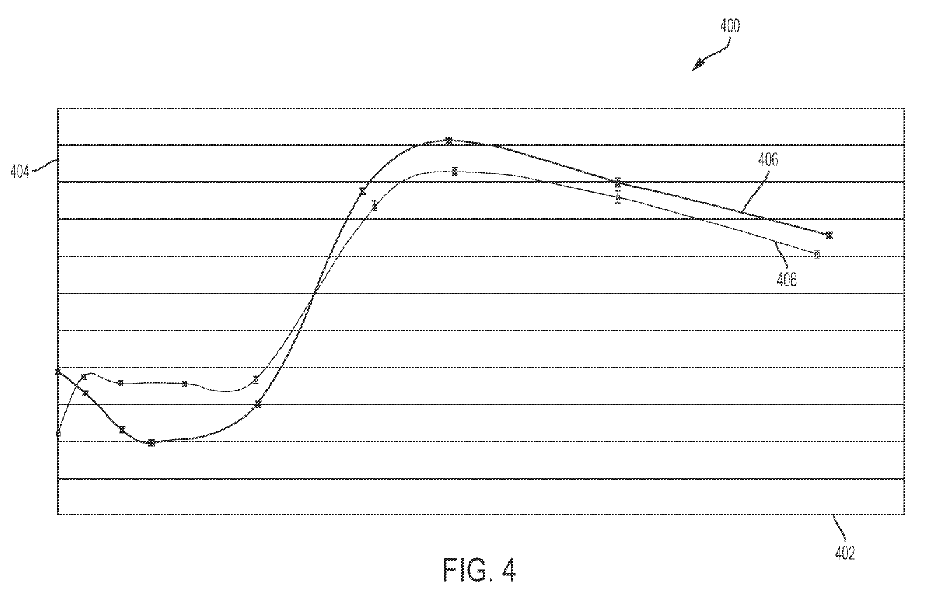

FIG. 4 is a graph 400 illustrating an improvement in reducing the residual tensile stress as a result of practicing a method of the present disclosure. The horizontal axis 402 of the graph 400 corresponds to the depth extending from the surface into the material underlying the surface of the crank pin and the vertical axis 404 corresponds to the magnitude of the residual tensile stress. Line 406 represents the residual tensile stress that results from a conventional induction hardening technique and line 408 represents the residual tensile stress that results from the use of an exemplary induction pre-heating process prior to the induction hardening in accordance with the present disclosure. As is clearly illustrated, there is a desirable reduction in the residual tensile stress in the sub-surface crank pin material between the conventional induction hardening 406 and the induction pre-heating and subsequent inductive hardening 408 in accordance with the present disclosure.

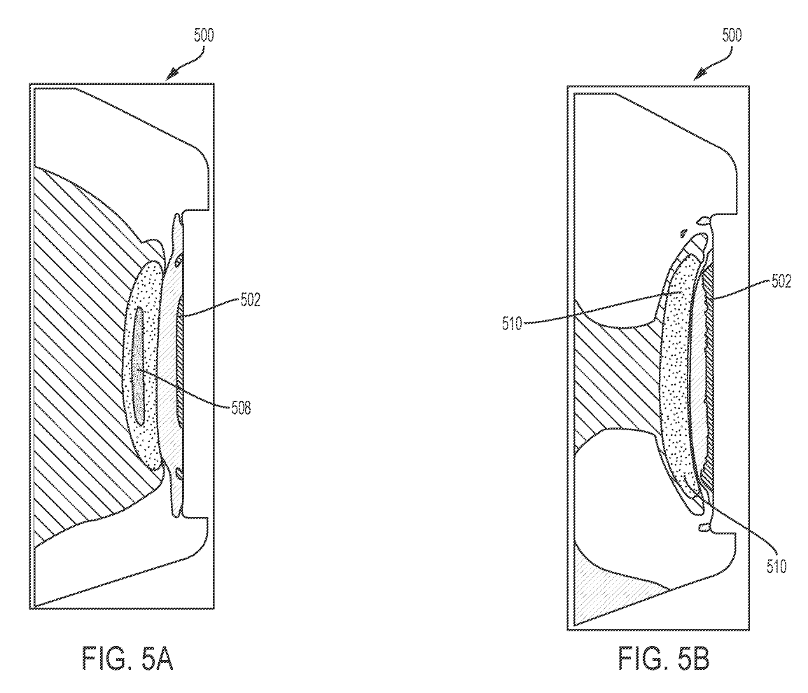

FIGS. 5A and 5B schematically illustrate the residual axial tensile stress and residual hoop tensile stress, respectively, in cross-sectional views of a crank pin portion 500 of another exemplary crankshaft having a hollow cross-section which has undergone inductive pre-heating of the surface 502 of the crank pin in accordance with the present disclosure. FIGS. 5A and 5B clearly illustrate the magnitude of the residual stress in the material underlying the surface 502 of the crank pin. In comparison to the residual axial tensile stress and residual hoop tensile stress of the crank pin portion 200 of FIGS. 2A and 2B, there is a clear reduction in the magnitude of the subsurface residual axial tensile stress and residual hoop tensile stress of the crank pin portion 500 of FIGS. 5A and 5B. While there may generally be some residual axial tensile stress in the subsurface at area 508, the magnitude of that residual axial tensile stress is lower than that of corresponding area 208 in the crank pin portion 200 of FIG. 2A. Similarly, the residual hoop tensile stress in the subsurface areas 510 are reduced in comparison to that of corresponding areas 210 in the crank pin portion 200 of FIG. 2B.

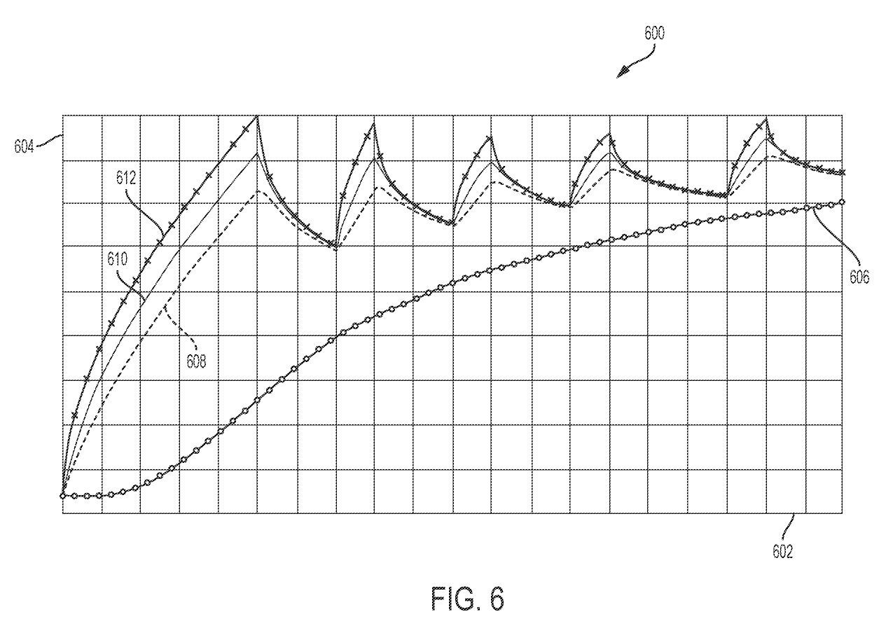

FIG. 6 is a graph 600 illustrating another exemplary induction pre-heating in accordance with the present disclosure. Similar to that of the graph 300 of FIG. 3, the horizontal axis 602 of the graph 600 corresponds to the elapse of time, while the vertical axis 604 corresponds to material temperature, line 606 represents the material temperature of the material at the core of the crankshaft underlying the surface of the crankpin and lines 608, 610, and 612, illustrate the material temperatures progressing from closer to the core at 608 to the surface 612, respectively. In the exemplary inductive heating method illustrated in FIG. 6, the inductive heating process includes a series of inductive heating pulses. In particular, the inductive heating method of FIG. 6 includes a first inductive heating pulse of about ten seconds, and four subsequent inductive heating pulses of about two seconds each for a total of five inductive heating pulses. The inventors of the present disclosure discovered that pulsing of the inductive heating further reduced the level of subsurface residual tensile stress remaining after a subsequent inductive hardening process. The plurality of inductive heating pulses tend to improve the temperature uniformity in the crankpin portion of the crank shaft, which, in turn, tends to reduce the residual tensile stress. The number of pre-inductive hardening, inductive heating pulses in accordance with the present disclosure may be varied without limitation. In an exemplary aspect, the pulsing may be achieved by periodically turning an alternating current in conductive coil in a tool on and off and/or cycling the intensity of the inductive field that is generated by the induction coil.

In contrast to an inductive hardening process, an inductive heating process in accordance with the present disclosure introduces heat into the crankshaft at a rate that is less than that of inductive hardening. The reduced heating rate provides sufficient time for the heat to distribute through the affected area such that it substantially improves the uniformity of the temperature in the area adjacent to the surface being treated prior to inductively hardening. The slower heating rate provides enough time for the heat to transfer more thoroughly throughout the crank pin material and, in particular, more uniformly throughout the subsurface material. Even with the reduced rate of heating, the inductive heating occurs quickly enough such that the method may be incorporated into a production process without significantly adversely impacting that process. In an exemplary embodiment, the inventive inductive heating process may rely upon the same tool which may be subsequently used for the inductive hardening process. In this manner, the overall process is greatly simplified, especially in comparison to those conventional methods which may have had to move the crankshaft into an oven and/or furnace and back out again.

In an exemplary aspect, the inductive heating of the present disclosure is at a lower heating rate than that of the subsequent inductive hardening process. The reduced heating rate, as explained above, provides the opportunity for the heat to more uniformly distribute throughout the affected area. In general, the lower heating rate may be provided by reducing the power density of the inductive field, pulsing the field and/or increasing the amount of time in comparison to that of inductive hardening.

Further, in an exemplary aspect, pulsing of the inductive heating may enable and/or improve the localization of the heating to only those areas of the part where such heating is desirable.

An additional benefit to the inductive pre-heating of the present disclosure in comparison to other attempts at reducing the residual stress, is an overall reduction in the amount of energy consumed by the process. Heating the entire crankshaft in an oven or furnace not only requires additional energy to heat the entire crankshaft, but also generally requires heating of the oven and/or furnace which may be a significant source of waste heat and wasted energy.

In an exemplary aspect, heating the crankshaft surface includes inductively heating the crankshaft surface however the present disclosure is not intended to be so limited. Any method which may heat the crankshaft surface such as, for example, inductive heating, laser heating, and/or the like is intended to be encompassed by the present disclosure without limitation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for heat treating a crankshaft surface on a crankshaft for a vehicle propulsion system, the method comprising:
heating the crankshaft surface to a first temperature; and
heating the crankshaft surface to a second temperature that is higher than the first temperature.

2. The method of claim 1, further comprising quenching the crankshaft surface to harden the crankshaft surface.

3. The method of claim 1, wherein heating the crankshaft surface comprises inductively heating the crankshaft surface.

4. The method of claim 3, wherein heating the crankshaft surface to a first temperature comprises applying a plurality of inductive field pulses to the crankshaft surface.

5. The method of claim 3, wherein heating the crankshaft surface to a first temperature comprises applying a first inductive field having a first intensity and heating the crankshaft surface to a second temperature comprises applying a second inductive field having a second intensity that is higher than the first intensity.

6. The method of claim 3, wherein heating the crankshaft surface to a first temperature comprises inductively heating the crankshaft surface at a first heating rate and heating the crankshaft surface to a second temperature comprises inductively heating the crankshaft surface at a second heating rate that is higher than the first heating rate.

7. The method of claim 3, wherein heating the crankshaft surface to a first temperature comprises applying a first inductive field having a first power density and heating the crankshaft surface to a second temperature comprises applying a second inductive field having a second power density that is higher than the first power density.

8. The method of claim 1, wherein inductively heating of the crankshaft surface to the first temperature comprises applying an alternating current to a coiled conductor and wherein inductively heating the crankshaft surface to the second temperature comprises applying another alternating current to the coiled conductor.

9. The method of claim 1, wherein heating the crankshaft surface to a first temperature comprises applying a first inductive field for a first period of time and heating the crankshaft surface to a second temperature comprises applying a second inductive field for a second period of time that is shorter than the first period of time.

10. The method of claim 1, wherein the crankshaft surface comprises one of a crankpin surface and a bearing journal surface.

11. The method of claim 1, wherein the crankshaft comprises a hollow crankshaft.

12. The method of claim 1, wherein heating the crankshaft surface to a first temperature comprises heating material underlying the crankshaft surface to a substantially uniform temperature.

13. The method of claim 1, wherein the first temperature is below an austenitizing temperature of the crankshaft surface.

14. The method of claim 1, wherein the first temperature is below a eutectoid temperature of the crankshaft surface.

15. The method of claim 1, wherein the first temperature is below an AC1 temperature of the crankshaft surface.

16. The method of claim 1, wherein the second temperature is above an austenitizing temperature of the crankshaft surface.

17. The method of claim 1, wherein the second temperature is above an AC3 temperature of the crankshaft surface.

18. A method of inductively hardening a crankshaft surface on a crankshaft for a vehicle propulsion system, the method comprising:
applying a first inductive field having a first intensity to the crankshaft surface to raise a temperature of the crankshaft surface to a first temperature that is below an austenization temperature of a crankshaft material;
applying a second inductive field having a second intensity to the crankshaft surface to raise the temperature of the crankshaft surface to a second temperature that is at least equal to the austenization temperature of the crankshaft material; and
quenching the crankshaft surface to a temperature below the second temperature to harden the crankshaft surface.
